(19) United States
(12) Patent Application Publication
(10) Pub. No.: US 2023/0347475 A1
(43) Pub. Date: Nov. 2, 2023

(54) KNIFE HANDLE WITH INTEGRATED SHARPENER

(71) Applicants: Kevin Carson McAllister, Highland, UT (US); Tyler Carson, Highland, UT (US); Jaxon Carson, Bluffdale, UT (US); Cade Carson, American Fork, UT (US)

(72) Inventors: Kevin Carson McAllister, Highland, UT (US); Tyler Carson, Highland, UT (US); Jaxon Carson, Bluffdale, UT (US); Cade Carson, American Fork, UT (US)

(21) Appl. No.: 18/141,852

(22) Filed: May 1, 2023

Related U.S. Application Data
(60) Provisional application No. 63/337,424, filed on May 2, 2022.

(51) Int. Cl. B24D 15/08; B26B 1/02; B26B 11/00; F23Q 1/06

(52) U.S. Cl. CPC B24D 15/084; B26B 1/02; B26B 11/001; F23Q 1/06

(57) ABSTRACT

A knife handle comprising a handle body with a proximal end and a distal end, a sharpener body removably attached to the handle body, the sharpener body comprising at least one cut-away for housing a replaceable sharpener, the sharpener body rotatable relative to the handle body, and a selectively actuatable locking mechanism for locking the sharpener body in place on the handle body. The selectively actuatable locking mechanism may have a first, locked position wherein the sharpener body cannot rotate relative to the handle body and a second, open position wherein the sharpener body can rotate relative to the handle body. The selectively actuatable locking mechanism may be biased in the first, locked position.

### CLAIM FOR PRIORITY

This application claims priority to and the benefit of U.S. Provisional Patent Application No. 63/337,424, filed May 2, 2022 and titled, “Knife Handle With Integrated Sharpener,” the entire contents of which are incorporated herein by reference.

### TECHNICAL FIELD

The present disclosure relates generally to a hand knife and tools for sharpening cutting edges of knives. More specifically, and without limitation, the present disclosure relates to a foldable hand knife with an integrated sharpening device.

### BACKGROUND

In order to make a knife or similar tool sharp, a user may use various forms of blade sharpening tools. Such blade sharpening tools include electric knife sharpeners, pull through sharpeners, whetstones, a sharpening steel tool, and others. These tools are not always readily available when a user needs to sharpen a particular blade, and carrying such tools in addition to certain blades, like pocketknives and the like, can be inconvenient and cumbersome.

### SUMMARY OF DISCLOSURE

This disclosure is related to a knife handle comprising a handle body with a proximal end and a distal end, a sharpener body removably attached to the handle body, the sharpener body comprising at least one cut-away for housing a replaceable sharpener, the sharpener body rotatable relative to the handle body, and a selectively actuatable locking mechanism for locking the sharpener body in place on the handle body. The selectively actuatable locking mechanism may have a first, locked position wherein the sharpener body cannot rotate relative to the handle body and a second, open position wherein the sharpener body can rotate relative to the handle body. The selectively actuatable locking mechanism may be biased in the first, locked position.

The knife handle may also comprise a knife blade attached to the handle body, the knife blade being rotatable relative to the handle body.

The knife handle may also comprise a fire-starting element attached to the handle body, the first starting element being rotatable relative to the handle body.

The at least one cut-away for housing a replaceable sharpener on the sharpener body may comprise a first cut-away for housing a replaceable fine sharpener and a second cut-away for housing a replaceable coarse sharpener.

### BRIEF DESCRIPTION OF DRAWINGS

The drawings are illustrative and not limiting of the scope of the invention which is defined by the appended claims. Not every element of the disclosure can be clearly displayed in a single drawing, and as such not every drawing shows each element of the disclosure. The components in the drawings are not necessarily to scale relative to each other. Like reference numerals designate corresponding parts throughout the several views.

FIG. 1 is a perspective view of a knife handle with a removable sharpener body.

FIG. 2 is a side view of the knife handle of FIG. 1.

FIG. 3 is another side view of the knife handle of FIG. 1.

FIG. 4 is a side view of a distal end of the knife handle of FIG. 1.

FIG. 5 is a side view of the distal end of the knife handle of FIG. 1.

FIG. 6 is a side perspective view of the knife handle of FIG. 1 with the removable sharpener body removed from the knife handle.

FIG. 7 is a first side view of the removable sharpener body of the knife handle of FIG. 1.

FIG. 8 is a cut-away view of the sharpener body of the knife handle of FIG. 1.

FIG. 9 is a side perspective view of the sharpener body of the knife handle of FIG. 1.

FIG. 10A is a side view and FIG. 10B is a top side perspective view of a knife or blade having the knife handle of FIG. 1.

FIG. 11 is side perspective view of the knife of FIGS. 10A-10B being sharpened using the sharpener body of the knife handle of FIG. 1.

FIG. 12 is a top side perspective view of another embodiment of a knife handle with a removable sharpener body, according to the present disclosure.

FIG. 13 is a side perspective view of the knife handle of FIG. 12.

FIG. 14 is a side perspective view of the knife handle of FIG. 12.

FIG. 15 is a side perspective view of a second side of the knife handle of FIG. 12.

FIG. 16 is an exploded view of the components of the knife handle of FIG. 12.

### DETAILED DESCRIPTION

The present disclosure relates generally to a system and device for a knife handle that includes a sharpening element.

As used herein, “proximal” refers to a portion of the system or device that is closer to the user when the knife handle is in the user's hand in use, and “distal” refers to a portion of the system or device that is farther from the user. For example, the systems and methods herein may have a proximal end, and a distal end, the distal end for connection to a knife blade.

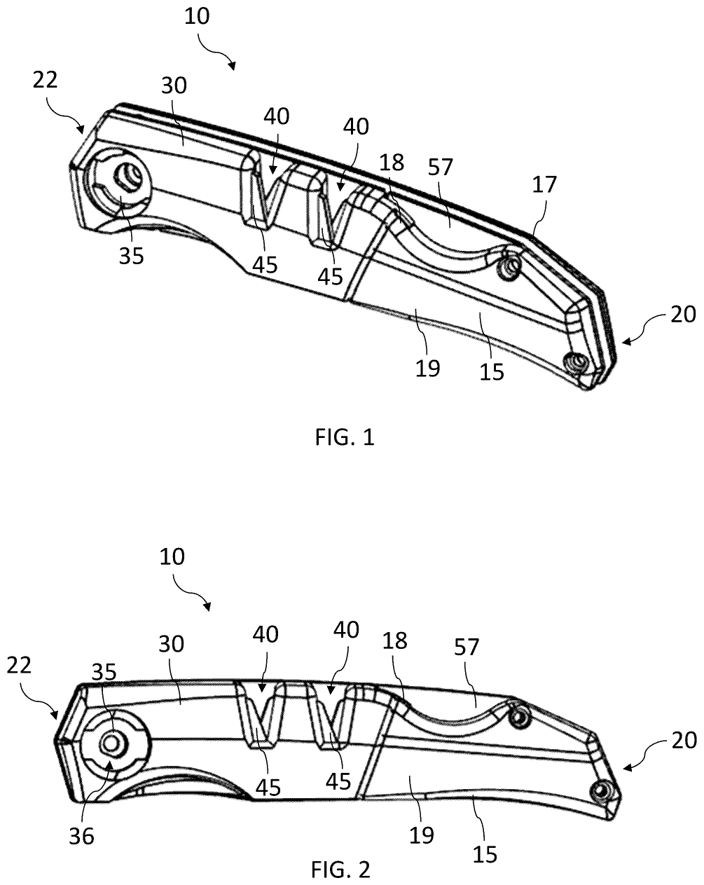

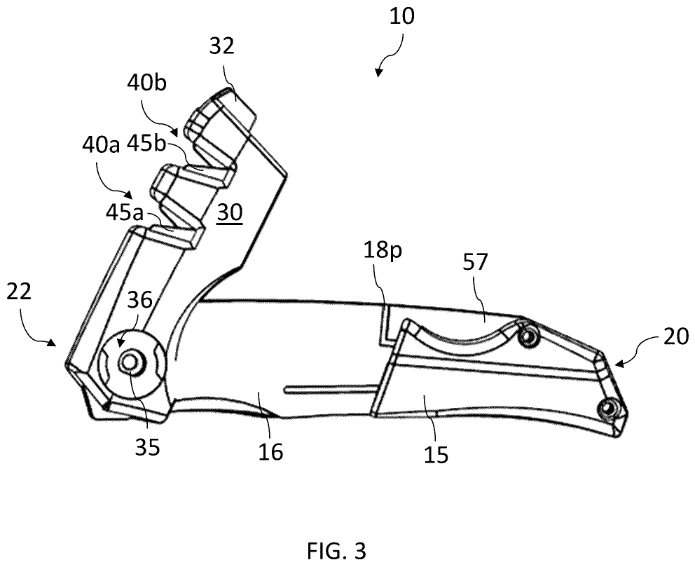

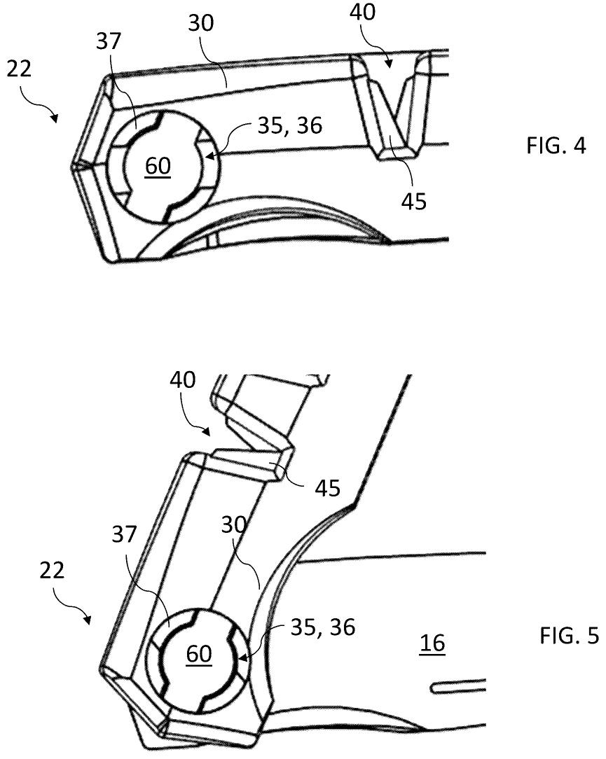

Referring to FIGS. 1-3, an exemplary configuration of an embodiment of a knife handle 10 is shown. The knife handle 10 may comprise a handle body 15 with a proximal end 20 and a distal end 22. The handle body 15 may include a front side 19 and a back side 17, with at least one plate 57 disposed between the front and back sides 19, 17. In some embodiments, the front side 19 includes a groove 18 that receives a portion of the sharpener body 30. For example, in some embodiments, the groove 18 receives a tab (see tab 32 of FIG. 3) of the sharpener body 30 to (i) help secure the sharpener body 30 to the handle body 15 and (ii) to secure the sharpener body 30 in a closed configuration.

The knife handle 10 may also comprise a sharpener body 30, which may be removably attached to the handle body 15. By way of example and not limitation, the sharpener body 30 may be attached to the distal end 22 of the knife handle 10 at a pivot point 35 around which the sharpener body 30 may be rotated such that the sharpener body 30 may be pivoted between a closed configuration (see FIG. 2) and an open configuration (see FIG. 3).

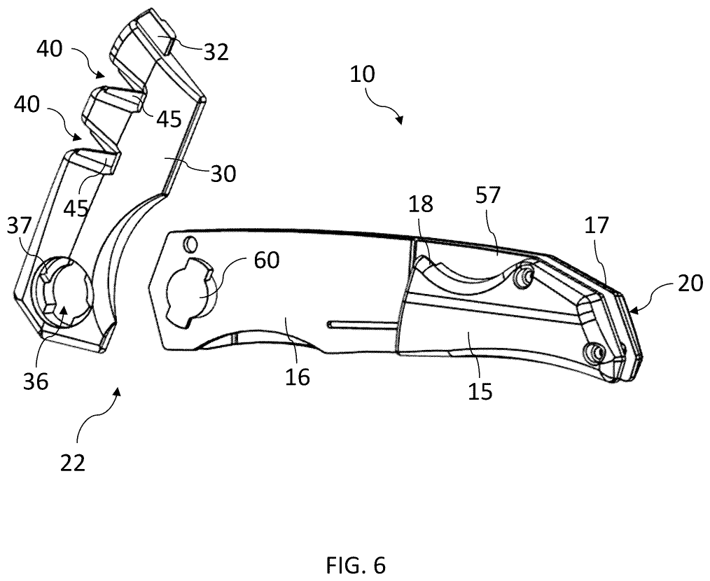

As discussed more fully below, in some embodiments, the sharpener body 30 defines a cavity 36 corresponding to the pivot point 35. The cavity 36 of the sharpener body 30 may be sized and shaped to receive an attaching mechanism or pin (see pin 60 of FIGS. 6-8).

The sharpener body 30 may also comprise at least one cut-away 40 for housing a sharpener 45, which may be a knife sharpener. In the embodiment shown in FIGS. 1-3, two cut-aways 40 are each provided with a knife sharpener 45. Each cut-away 40 of the at least one cut-away 40 may house a separate sharpener 45. Sharpener 45 may comprise any number of suitable sharpeners depending on the intended use thereof. For example, sharpener 45 may comprise a v-type knife sharpener. The sharpener 45 may also be disposable or replaceable. In some embodiments, the sharpener 45 may also include two sharpeners 45, such as a fine sharpener and/or a coarse sharpener. The sharpener 45 may also comprise a metal sharpener or a ceramic sharpener.

Referring to FIG. 3, the at least one cut-away 40 may comprise a first cut-away 40A for housing a replaceable fine sharpener 45A and a second cut-away 40B for housing a replaceable coarse sharpener 45B.

The knife handle 10 may also comprise a selectively actuatable locking mechanism for locking the sharpener body 30 in place on the handle body 15. In some embodiments, the actuatable locking mechanism includes the at least one plate 57. The locking mechanism may comprise a first, locked position (see FIG. 2) in which the sharpener body 30 cannot rotate relative to the handle body 15 and a second, open position (see FIG. 3) in which the sharpener body 30 can rotate relative to the handle body 15. The selectively actuatable locking mechanism may be biased in the first, locked position. By way of example and not limitation, the knife handle 10 may comprise a push button, which may be pressed to release the sharpener body 30 from the bias in the first, locked position so that the sharpener body 30 may rotate relative to the handle body 15.

In some embodiments, the at least one plate 57 approximates a push button, such that the at least one plate 57 may be pressed to release the sharpener body 30 from the handle body 15. Specifically, pressing the at least one plate 57 may release the tab 32 from the groove 18, allowing the sharpener body 30 to rotate relative to the handle body 15. In some embodiments, the groove 18 is incorporated into the handle body 15. In some embodiments, the groove 18 is formed of a gap or space between the at least one plate 57 and the second plate 16 (see groove 18p of FIG. 3). In some embodiments, the groove 18 includes both a groove in the handle body 15 and a gap between the at least one plate 57 and the second plate 16.

In some embodiments, the handle body 15 includes a second plate 16 adjacent to the at least one plate 57. In some embodiments, the second plate 16 defines part of the pivot point 35. In some embodiments, the second plate 16 provides structural integrity to the knife handle 10.

Referring to FIGS. 4-6, the knife handle 10 may also comprise an attaching mechanism or pin 60 that aids in locking the sharpening body 30 in place. The attaching mechanism 60 can be a pin, a switch or a type of key, for example. When the locking mechanism (e.g., the at least one plate 57) has been set to the open position such that the sharpener body 30 can rotate relative to the handle body 15, the sharpening body 30 and the attaching mechanism 60 may be oriented relative to one another such that they are in a first, attached/locked position (see FIG. 4), which may serve to maintain the sharpening body 30 in a reversibly fixed manner to the handle body 15.

In some embodiments, the cavity 36 of the sharpening body 30 may include one or more walls 37. The one or more walls 37 may provide a stop for the attaching mechanism 60 when the sharpening body 30 and the attaching mechanism 60 are in the attached/locked position. Specifically, the attaching mechanism 60 may include wings or tabs that abut the one or more walls 37 of the cavity 36 defined within the sharpener body 30. Additionally, and/or alternatively, the sharpener body 30 and the attachment mechanism 60 may be oriented relative to each other such that they are in a second, detachable/open position (see FIG. 5), which may allow the sharpening body 30 to be selectively removed from the handle body 15. Specifically, the attaching mechanism 60 may include wings or tabs that align with the size and/or shape of the cavity 36 defined within the sharpener body 30, such that the wings clear the one or more walls 37 and can be removed from the cavity 36.

FIG. 6 illustrates how the sharpening body 30 may be removed from the handle body 15 after the sharpening body 30 and the attaching mechanism 60 have been oriented in the detachable/open position. For example, as illustrated, the orientation of the attaching mechanism 60 is aligned with the orientation of the cavity 36, such that the attaching mechanism 60 can be removed from the cavity 36, thereby allowing the sharpener body 30 to be removed from the handle body 15. In some embodiments, the attaching mechanism 60 extends from the second plate 16. In some embodiments, the attaching mechanism 60 extends from the back side 17 of the handle body 15 and through the second plate 16.

Though not illustrated, in some embodiments, the sharpening body 30 additionally includes a cap to go over or cover the cavity 36.

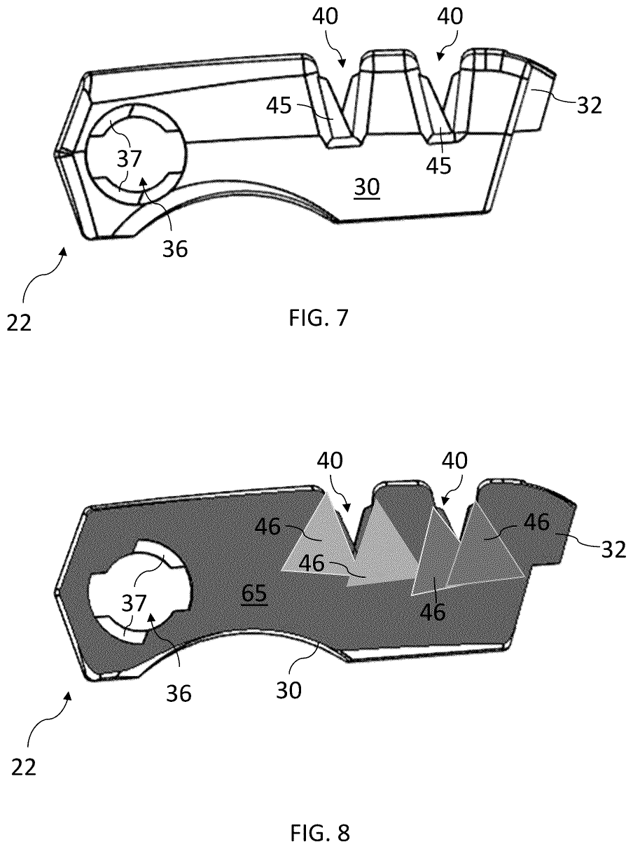

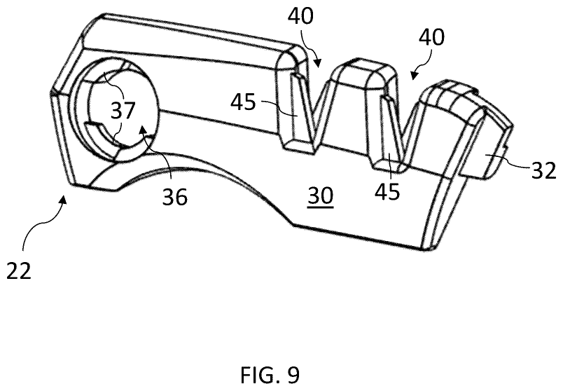

FIGS. 7-9 illustrate one example of the sharpener body 30 removed from the handle body 15 of the knife handle 10. Referring to FIG. 8, which shows a cut-away view of the interior of the handle body 15, the sharpener(s) 45 may comprise at least two sharpening elements 46 that are fixed to the sharpening body 30 such that the sharpening elements 46 form the shape of a “V” in the at least one cut-away 40 for housing the sharpener 45. As illustrated in FIG. 8, the sharpening elements 46 of the sharpener 45 may be reversibly/removably fixed to an inner surface 65 of the sharpening body 30. In other embodiments, the sharpening elements 46 of the sharpener(s) 45 may be reversibly fixed to the sharpening body 30 in other ways, such as by inserting them into an internal portion of the sharpening body 30. Or, the sharpening elements 46 may be permanently fixed to the sharpening body 30. In configurations where the sharpening elements 46 are reversibly fixed, the sharpening elements 46 can be replaced over time.

In some embodiments, the knife handle 10 may also comprise a fire-starting element (not illustrated). U.S. Provisional Patent Application No. 63/337,424 (already incorporated herein by reference) illustrates various embodiments of the knife handle 10 having a fire-starting element. The fire-starting element may comprise a ferro rod fire starter, which may be an elongated rod of ferrocerium, which may be struck with another object to create sparks and start a fire. The fire-starting element may, by way of example and not limitation, be attached to the proximal end 20 of the knife handle 10 at a pivot point around which the fire-starting element may be rotated. The fire-starting element may be manually pivoted between a closed configuration and an open configuration. When the first starting element is in the closed configuration, the fire-starting element may be housed substantially within the handle body 15. Other accessories may also be attached to the handle as desired, such as a compass, a thermometer, etc.

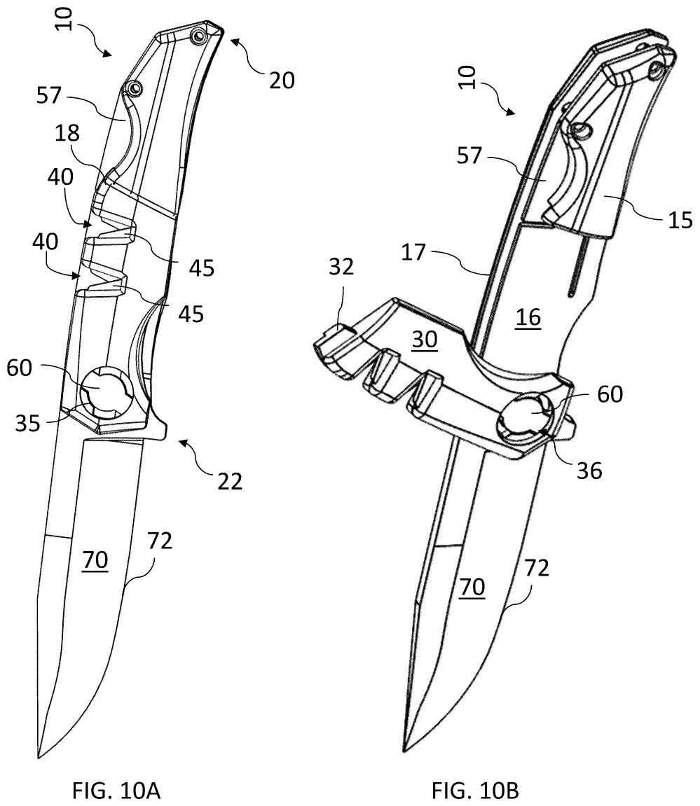

FIG. 10A illustrates a knife or blade 70 having the knife handle 10 of FIG. 1 in a first configuration and FIG. 10B illustrates the blade 70 having the knife handle 10 in a second configuration. The knife 70 has a cutting edge 72 that may be sharpened using the sharpening body 30. Specifically, the knife or blade 70 attaches to the knife handle 10 at a distal end 22 of the handle 10. In some embodiments, the knife 70 attaches to the knife handle 10 at the pivot point 35. FIG. 10A illustrates the blade 70 and handle 10 in a closed configuration, where the sharpening body 30 is secured to the handle body 15.

FIG. 10B illustrates the knife 70 and handle 10 in an open configuration, where the sharpening body 30 can be removed from the handle body 15. In some embodiments, the blade 70 attaches to the knife handle 10 via attaching mechanism 60. As before, in some embodiments, the attaching mechanism 60 extends from the second plate 16. In some embodiments, the attaching mechanism 60 extends from the back side 17 of the handle body 15 and through the second plate 16.

In some embodiments, the blade 70 is pivotally attached to the handle 10. Specifically, the knife 70 may rotate about the pivot point 35 and, in some embodiments, may be stored internally within the handle body 15. For example, the knife or blade 70 may rotate about the pivot point 35 and be internally stored between the sharpening body 30 and the second plate 16.

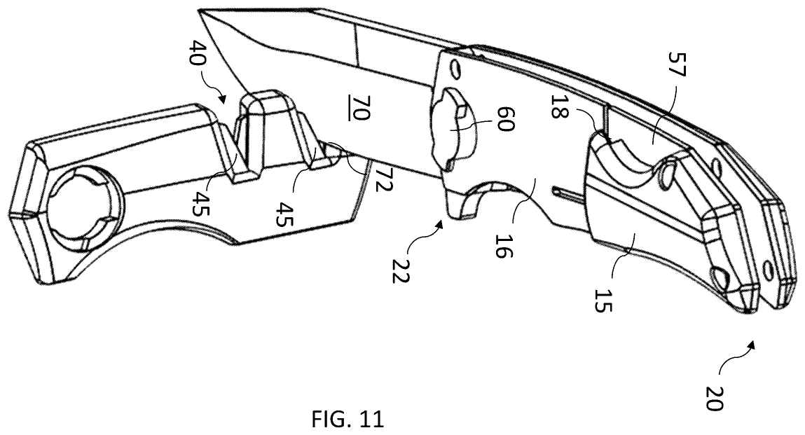

FIG. 11 illustrates the knife 70, specifically the cutting edge 72, in a sharpening position within the sharpening body 30. The sharpening body 30 has been removed from the handle body 15 via actuation of the at least one plate 57 to release the tab 32 from the groove 18. As before, the sharpening body 30 includes at least one cut-away 40 having a sharpener 45. The sharpener 45 can include two sharpeners 45, such as a fine sharpener and a coarse sharpener. Depending on a dullness of the cutting edge 72, the blade 70 can be sharpened using either the fine sharpener or the coarse sharpener. After sharpening the knife 70, the sharpening body 30 can be re-attached to the handle body 15.

In use, a user may handle and use the knife handle 10 in any number of suitable manners. By way of example and not limitation, the user may manipulate the locking mechanism to move the sharpener body 30 from the locked position to the open position in order to rotate the sharpener body 30 and selectively remove the sharpener body 30 from the handle body 15. The user may then desire to place a knife blade, such as knife 70, into the at least one cut-away 40 for housing the sharpener 45, and sharpen the knife blade with the sharpener 45 (see FIG. 11).

Alternatively, the user may then desire to pivot the fire-starting element from the closed configuration to the open configuration and strike the fire-starting element with the sharpener 45 of the at least one cut-away 40 in order to aid in starting a fire.

The user may then reattach the sharpen body 30 to the handle body 15 and manipulate the locking mechanism to move the sharpener body 30 from the open position back into the locked position. For example, the tab 32 of the sharpener body 30 may be inserted into the groove 18 of the handle body 15 (see FIGS. 1-3) and the at least one plate 57 may secure the tab 32 within the groove 18. After a certain amount of use, the user may remove the sharpener body 30 from the handle body 15 and replace the sharpener(s) 45 for subsequent use.

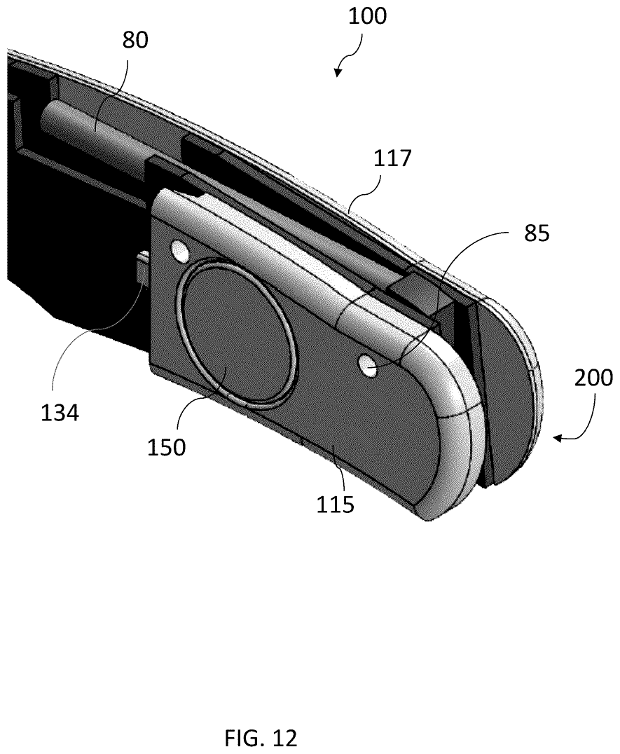

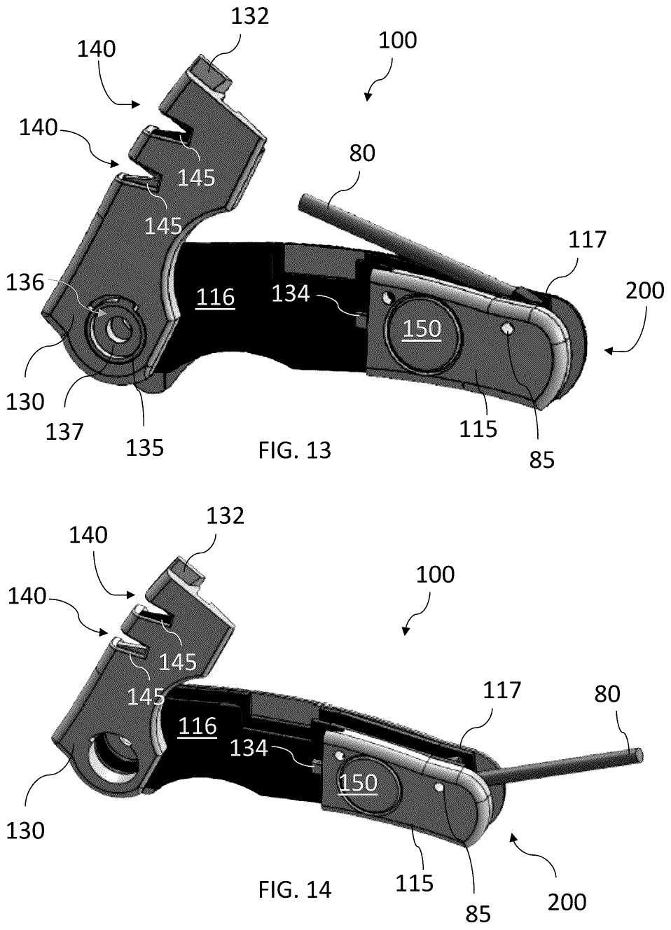

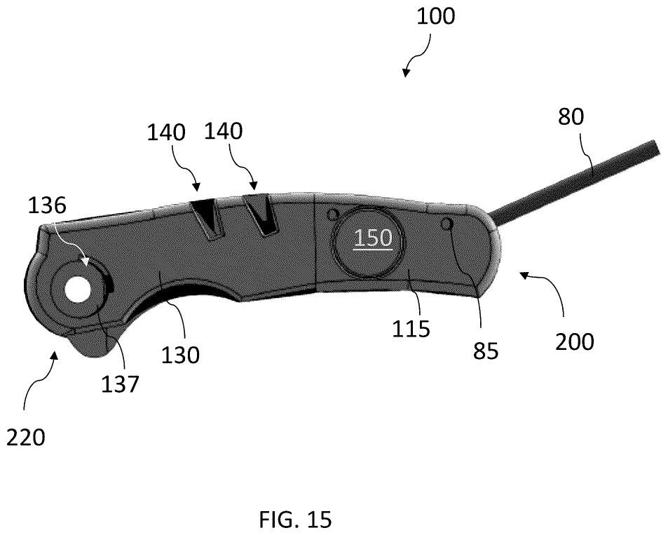

FIGS. 12-16 illustrate another embodiment of a knife handle 100 according to the present disclosure. As with knife handle 10, the knife handle 100 includes a handle body 115 having a back plate or back side 117, a second plate 116, and a proximal end 200 (distal end 220 of the handle body 115 is not illustrated). In some embodiments, the knife handle 100 may include a fire-starting element 80. The fire-starting element 80 may comprise a ferro rod fire starter, which may be an elongated rod of ferrocerium, which may be struck with another object to create sparks and start a fire. The fire-starting element 80 may, by way of example and not limitation, be attached to the proximal end 200 of the handle body 115 at a pivot point 85, around which the fire-starting element 80 may be rotated. The fire-starting element 80 may be manually pivoted between a closed configuration (see FIG. 12) and an open configuration (see FIGS. 13-14). As illustrated in FIG. 12, when the first starting element 80 is in the closed configuration, the fire-starting element 80 may be housed substantially within the handle body 115. Specifically, the fire-starting element 80 may be disposed between the handle body 115 and the back side 117. In some embodiments, the fire-starting element 80 may be disposed between the handle body 115 and the second plate 116. Other accessories may also be attached to the handle body 115 as desired, such as a compass, a thermometer, etc.

As with the knife handle 10, the sharpener body 130 is pivotally attached to the handle body 115 at pivot point 135. The sharpener body 130 may define a cavity 136 at the pivot point 135, where the cavity 136 is to receive a pin or attaching mechanism (e.g., attaching mechanism 60 of FIGS. 4-6). The cavity 136 may have an internal wall 137 to maintain the attaching mechanism in a locked/attached position. Specifically, the internal wall 137 may provide a stop for the attaching mechanism when the sharpening body 130 and the attaching mechanism are in the attached/locked position.

In some embodiments, the handle body 115 includes a button 150 that is an actuatable locking mechanism to lock and/or release the sharpener body 130 (see FIGS. 13-14) from the handle body 115. Specifically, the handle body 115 includes a tab 134 that is releasable from the sharpener body 130 by actuating the button 150. The tab 134 engages or interfaces with a tab 132 on the sharpener body 130 and actuation of the button 150 releases the engagement between the tab 134 of the handle body 115 and the tab 132 of the sharpener body 130. Upon release, the sharpener body 130 can be rotated and removed from the knife handle 100.

The sharpener body 130 includes at least one cut-away 140 to house at least one sharpener 145. As before, a user may desire to sharpen a blade or knife with the sharpener(s) 145. A user may also desire to pivot the fire-starting element 80 from the closed configuration to the open configuration and strike the fire-starting element 80 with the sharpener 145 of the at least one cut-away 140 in order to aid in starting a fire.

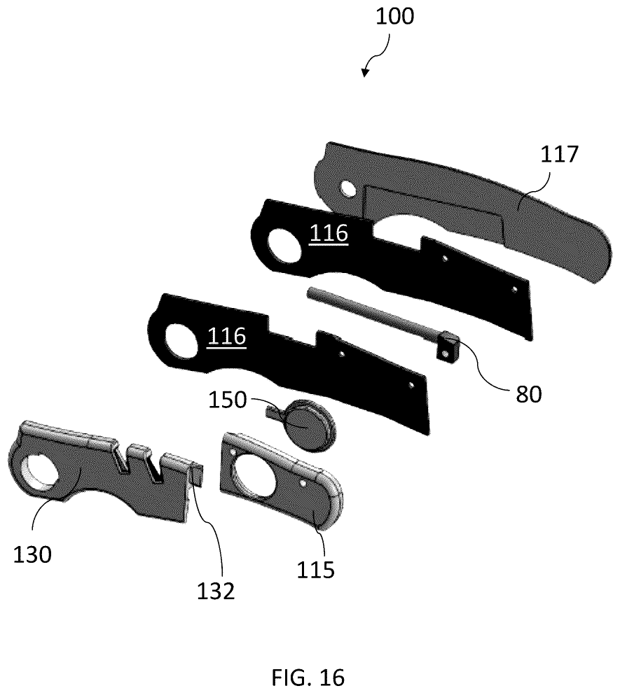

FIG. 16 illustrates an exploded view of the knife handle 100. As illustrated, the knife handle 100 includes the handle body 115 having a back side 117 and at least one second plate 116 disposed between the handle body 115 and the back side 117. The knife handle 100 also includes the sharpener body 130 with a tab 132 to lock the sharpener body 130 to the handle body 115. The handle body 115 may include an actuating mechanism, such as button 150, to facilitate release of the sharpener body 130 from the handle body 115. The knife handle 100 also includes a fire-starting element 80 housed within the handle body 115.

The description is only exemplary of the principles of the disclosure, and should not be viewed as narrowing the scope of the claims which follow, which claims define the full scope of the invention. Various aspects discussed in one drawing may be present and/or used in conjunction with the embodiment shown in another drawing, and each element shown in multiple drawings may be discussed only once. The described features, structures, or characteristics of configurations of the disclosure may be combined in any suitable manner in one or more configurations. In some cases, detailed description of well-known items or repeated description of substantially the same configurations may be omitted to facilitate the understanding of those skilled in the art by avoiding an unnecessarily redundant description. All statements herein reciting principles, aspects, and embodiments of the invention, as well as specific examples thereof, are intended to encompass equivalents thereof.

Reference in the specification to “one configuration” “one embodiment,” “a configuration” “an example,” or “an embodiment” means that a particular feature, structure, or characteristic described in connection with the configuration is included in at least one configuration, but is not a requirement that such feature, structure or characteristic be present in any particular configuration unless expressly set forth in the claims as being present. The appearances of the phrase “in one configuration” or “in one example” in various places may not necessarily limit the inclusion of a particular element of the disclosure to a single configuration, rather the element may be included in other or all configurations discussed herein.

As used in this specification and the appended claims, singular forms such as “a,” “an,” and “the” may include the plural unless the context clearly dictates otherwise. Thus, for example, reference to “a sharpener body” may include one or more of such sharpener bodies, and reference to “the handle” may include reference to one or more of such handles.

As used herein, the term “generally” refers to something that is more of the designated adjective than not, or the converse if used in the negative. As used herein, the term “about” is used to provide flexibility to a numerical range endpoint by providing that a given value may be “a little above” or “a little below” the endpoint while still accomplishing the function associated with the range, for example, “about” may be within 10% of the given number or given range. As used herein, a plurality of items, structural elements, compositional elements, and/or materials may be presented in a common list for convenience. However, these lists should be construed as though each member of the list is individually identified as a separate and unique member.

Numerical data may be expressed in a range format. This range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. For example, a numerical range of “about 5 to about 60” should be interpreted to include not only the explicitly recited values of about 1 to about 5, but also include individual values and sub-ranges within the indicated range. Thus, included in this numerical range are individual values such as 6, 7, 8, 9, etc., through 60, and sub-ranges such as from 10-20, from 30-40, and from 50-60, etc., as well as each number individually. This same principle applies to ranges reciting only one numerical value as a minimum or a maximum. Furthermore, such an interpretation should apply regardless of the breadth of the range or the characteristics being described.

While methods are described herein in discrete steps in a particular order for the sake of clarity, the steps do not require a particular order and more than one step may be performed at the same time. For example, a later step may begin before earlier step completes. Or, a later step may be completed before an earlier step is started. Additionally, the word “connected” and “coupled” is used throughout for clarity of the description and can include either a direct connection or an indirect connection.

Although the foregoing disclosure provides many specifics, such as use of the system in a foldable knife, other devices are contemplated and these should not be construed as limiting the scope of any of the ensuing claims. Other embodiments and configurations may be devised which do not depart from the scopes of the claims. Features from different embodiments and configurations may be employed separately or in combination. Accordingly, all additions, deletions and modifications to the disclosed subject matter that fall within the scopes of the claims are to be embraced thereby. The scope of each claim is indicated and limited only by its plain language and the full scope of available legal equivalents to its elements.

Furthermore, if any references have been made to patents and printed publications throughout this disclosure, each of these references and printed publications are individually incorporated herein by reference in their entirety.

1. A knife handle comprising:
a handle body with a proximal end and a distal end;
a sharpener body removably attached to the handle body, the sharpener body comprising at least one cut-away for housing a replaceable sharpener, the sharpener body rotatable relative to the handle body;
a selectively actuatable locking mechanism for locking the sharpener body in place on the handle body, the selectively actuatable locking mechanism having a first, locked position wherein the sharpener body cannot rotate relative to the handle body and a second, open position wherein the sharpener body can rotate relative to the handle body; and
wherein the selectively actuatable locking mechanism is biased in the first, locked position.

2. The knife handle of claim 1 further comprising a knife blade attached to the handle body, the knife blade being rotatable relative to the handle body.

3. The knife handle of claim 1 further comprising a fire-starting element attached to the handle body, the fire-starting element being rotatable relative to the handle body.

4. The knife handle of claim 1, wherein the at least one cut-away for housing a replaceable sharpener on the sharpener body comprises a first cut-away for housing a replaceable fine sharpener and a second cut-away for housing a replaceable coarse sharpener.

5. The knife handle of claim 1, wherein the sharpener body defines a cavity to receive an attaching mechanism, thereby attaching the sharpener body to the distal end of the handle body.

6. The knife handle of claim 1, wherein actuation of the selectively actuatable locking mechanism causes release of a tab of the sharpener body.

7. The knife handle of claim 6, wherein release of the tab of the sharpener body allows the sharpener body to rotate relative to the handle body.

8. The knife handle of claim 7, wherein the sharpener body can be removed from the handle body upon rotation of the sharpener body relative to the handle body.

9. A knife handle comprising:
a handle body having a front side and a back side and at least one plate disposed between therebetween; and
a sharpener body rotatably attached to a distal end of the handle body, the sharpener body comprising:
a first cut-away housing a first sharpener,
a second cut-away housing a second sharpener,
a tab for securing the sharpener body to the handle body when the sharpener body is in a first, closed configuration, and
a cavity defined in a distal end of the sharpener body, the cavity for receiving an attaching mechanism to attach the sharpener body to the distal end of the handle body.

10. The knife handle of claim 9, wherein the front side of the handle body defines a groove to receive the tab of the sharpener body in the first, closed configuration.

11. The knife handle of claim 9, wherein the at least one plate includes a first plate for securing the sharpener body in the first, closed configuration and a second plate adjacent the first plate.

12. The knife handle of claim 9, wherein the at least one plate is actuatable such that actuation of the at least one plate releases the tab of the sharpener body such that the sharpener body is in a second, open configuration.

13. The knife handle of claim 12, wherein the sharpener body can be removed from the handle body when the sharpener body is in the second, open configuration.

14. The knife handle of claim 12, wherein the attaching mechanism is aligned with the cavity of the sharpener body when the sharpener body is in the second, open configuration, such that the sharpener body can be removed from the handle body.

15. The knife handle of claim 9, further comprising a blade attached to the distal end of the handle body and the sharpener body.

16. The knife handle of claim 15, wherein the blade is attached in between the handle body and the sharpener body via the attaching mechanism.

17. The knife handle of claim 15, wherein the blade comprises a cutting edge to be sharpened by the sharpener body when the sharpener body is in a second, open configuration.

18. The knife handle of claim 15, wherein the at least one plate is actuatable such that actuation of the at least one plate releases the tab of the sharpener body such that the sharpener body is in a second, open configuration.

19. The knife handle of claim 18, wherein the sharpener body can be removed from the handle body when the sharpener body is in the second, open configuration.

20. The knife handle of claim 9, wherein the first sharpener and the second sharpener have a different grit, such that the first sharpener is a fine sharpener and the second sharpener is a coarse sharpener.

21. The knife handle of claim 9, further comprising a fire-starting element rotatably housed between the front side and the back side of the handle body.

22. The knife handle of claim 21, wherein the fire-starting element comprises a ferro rod.
